(19) United States
(12) Patent Application Publication
(10) Pub. No.: US 2008/0010219 A1
(43) Pub. Date: Jan. 10, 2008

(54) Interactive credential system and method

(76) Inventor: Dwayne Paul Hargroder, Lafayette, LA (US)

Correspondence Address: PERRET DOISE;A PROFESSIONAL LAW CORPORATION, P.O. DRAWER 3408, LAFAYETTE, LA, 70502-3408, US

(21) Appl. No.: 11/710,885

(22) Filed: Feb. 26, 2007

Related U.S. Application Data
(63) Continuation-in-part of application No. 11/480,679, filed on Jul. 3, 2006.

(51) Int. Cl. G06Q 99/00

(52) U.S. Cl. 705/76

(57) ABSTRACT

An interactive credential system and method. The system comprises a database containing surveyed information, an authorization code for authorizing access to the database and a control device, operatively associated with the database, for presenting weighted scores. The system further includes a surveyed party processor operatively associated with the control device, and wherein the surveyed party processor is capable of transmitting the authorization code to view the surveyed information. The system further comprises a participant processor that is capable of requesting authorization to download the employee information, including weighted scores computed from the system's algorithms. A notification function is included in order to alert participants when a weighted score declines/exceeds a predetermined threshold.

This application is a continuation-in-part application of my co-pending application bearing Ser. No. 11/480,679, filed on 3 Jul. 2006 and entitled “INTERACTIVE EMPLOYMENT CREDENTIAL SYSTEM AND METHOD”.

### BACKGROUND OF THE INVENTION

This invention relates to the information technology industry for the systematic implementation of resource management using employee/employer dynamics and participant surveys. More specifically, but not by way of limitation, this invention relates to an interactive credential survey system and method.

As the insurance industry has incorporated the use of Medical Information Bureaus (MIB's) for Life and Health Insurance underwriting and Motor Vehicle Reports (MVR's) and claims history detail provided by “CLUE” for property and casualty insurance risks, this invention, in one embodiment, is designed to launch an internet site to provide on demand employee information on a prospective hire for employment underwriting by full disclosure of credentials as well as prior work history, performance and safety provisions.

The system herein disclosed consist of an interactive web-based information resource center for the management of employee credentials as well as prior work history and performance as reported by member companies. The system may include a certification program to award all companies that incorporate the system for the maintenance of current employees, new hires, as well as the reporting of all terminated employees with the recordation of exit interviews within the employee master file. The system allows for a second tier of performance information for employers and independent contractors in order to provide consumers with full disclosure of employer past performance and weighted scoring. The system may include the launching of a secure business web site through the incorporation of password protection and personal pin numbers to insure the privacy of each applicant's information and the restriction of use by unauthorized personnel. Such a system does not exist in the prior art.

In another embodiment, an interactive credential system and method that utilizes a survey system is also disclosed. Survey information of a surveyed party is compiled from various respondents. The survey information is used by participants of the system, as fully disclosed in the description of the preferred embodiments.

Therefore, there is a need for an on-demand systematic employee management tool in order to improve the underwriting process of new hires and the management of existing employees and industry specific credentials. By virtue of the disclosed system, member companies will experience economic efficiencies from the reduction of Human Resources activity for new hire verification, reference checks on discharged employees, and insurance cost savings by the improved management practices and improved safety records by program implementation. Additionally, there is also a need for an interactive credential system and method, wherein an entity can be surveyed by various respondents, and calculated and weighted results of the surveyed information is made available to selected participants. These needs, and many others, will be met by the following described system.

### SUMMARY OF THE INVENTION

In a first preferred embodiment, the system will provide baseline employment credentials and automatic updating of time sensitive information, such as 10 years employed in 2005 will automatically be 11 years in 2006, etc. Certifications and continuing education requirements will be updated instantaneously and reflect status of such requirements. The system can provide for automatic downloads with certification agencies in order to receive updated information electronically in an approved format.

A sample illustrative list of agencies that can communicate data includes: the State Real Estate Commission, Insurance Agency, Legal and Bar Associations, Barbers, Hair Dressers, State Board of Nursing, and other approved certification agencies. The collected information will be available to all member companies through client authorization much like credit reports.

The database of employment records will then be available to member companies for a nominal fee. All employees in the system shall have identification cards with specified identification numbers that can be made available to the human resources departments to pull employment records within seconds. The system creates an employment database that will receive all information regarding that applicant's profession, duration of employment, special achievements/certifications and the current status of each. A real time resume that is constantly updated is possible with the teachings of this invention.

In this first embodiment, a provision can be included to better educate the consumers about artesian contractors, like carpenters, roofers, electricians, etc. These members could have information about their job performance and personal references. The system could provide a template covering the vast array of occupations and certifications. The system could also provide a template to file on contractors for poor performance. This will be in the form of a complaint similar to a complaint form filed on an insurance company with the department of insurance.

In a second preferred embodiment, an interactive employment credential system is disclosed. The system comprises a database containing employee information, authorization means for authorizing access to the database and control means, operatively associated with the database, for presenting the employee information in a first format. The employee information is processed through an algorithm utilizing several hundred employment dynamics in order to compute an employer/employee weighted score. The interactive system provides for an authorization code for authorizing access to the database and control device, operatively associated with the database, in order for disclosure of score presentation. The system further includes an employee processor operatively associated with the control means, and wherein the employee processor is capable of transmitting authorization to view the employee information.

In this second embodiment, the system further comprises an employer processor in communication with the authorization means, and wherein the employer processor is capable of requesting authorization to download the employee information. The control means may contain means for requiring that the employer request includes payment of the request fee and means for requiring that the employee authorization includes payment of the request fee. In the most preferred embodiment, the first format of the employee information includes a weighted score performed by algorithm. The employee information may consist of health information, education information, criminal information, and/or professional certification information.

A method of providing employee information is also disclosed. The method comprises storing employee information on a database, transmitting authorization to view the employee information via an employee processor operatively associated with a control means, and authenticating and authorizing third parties access to the database. The method may further include presenting the employee information in a first format via the control means, and wherein the control means is operatively associated with the database.

The method may further comprise communicating an employer processor with the control means, and requesting authorization to download the employee information with the employer processor. In one embodiment, the step of requesting authorization to download employee information includes paying a request fee by the employer in order to view the employee information. Additionally, the step of transmitting authorization to make available employee information via an employee user processor may include paying a user fee by the employee in order to post the employee information to the database.

In a third embodiment, which is the most preferred embodiment of this disclosure, a method of providing survey information of a surveyed party is disclosed. The method comprises storing the survey information on a database, transmitting authorization to view the information via a surveyed party processor operatively associated with a control means, authenticating and authorizing third parties access to said database, and presenting the survey information in a first format via the control means, and wherein the control means is operatively associated with the database. The method further comprises communicating a participant processor with the control means and requesting authorization to download said survey information with the participant processor.

In one preferred embodiment, the step of requesting authorization to download the survey information includes paying a request fee by the participant in order to view the survey information. Also, the step of transmitting authorization to make available survey information via the surveyed party's processor includes paying a user fee by the surveyed party in order to post the surveyed party's information to the database. Additionally, the step of presenting the survey information in a first format includes utilizing an algorithm to calculate a weighted score of the survey information. The survey information is selected from the group consisting of a financial score, an academic score, an employment score, a character score, a medical score, a professional credential score, a reference score, a military score, a legal score or an insurance score. The method may also include transmitting an alert based on a predetermined criteria selected from the survey information. The participant may be selected from the group consisting of bankers, insurance companies, lenders, employers, and court systems.

In yet another most preferred embodiment, an interactive employment credential system is disclosed, wherein the system comprises a database comprising survey information of a surveyed party, authorization means for authorizing access to the database, and control means, operatively associated with the database, for presenting the survey information in a first format. This system also includes a survey party processor operatively associated with the control means, and wherein the survey party processor is capable of transmitting authorization to view the survey information, means for generating an alert when the survey information changes based on predetermined criteria, and means for transmitting the alert to participants in the system.

An advantage of the present disclosure is that companies would finally have an accountability program for the management of their employees and new hires with full disclosure. Another advantage is that workers will have to be accountable in order to maintain adequate weighted scores. It is believed that the workforce would be enhanced as they have a permanent record of performance.

Yet another advantage is that probation periods will be available for individuals that have experienced hard luck situations and have the opportunity to improve their scores. Another advantage is that companies could use these scores for merit pay and the incentive of good performers. Yet another advantage is that it is possible that companies that maintain a “threshold or average” employment of weighted scores of some predetermined level would receive special recognition and would be entitled to premium credits on large insurance programs.

Still yet another advantage is that employers will experience a reduced workload by not having to ever give a reference on an employee, and instead can log-on and download the appropriate file. Another advantage is that attorneys could use certain authorized information for discovery purposes. For instance, it will be possible to obtain credential information immediately about certifications, safety certification expirations, etc. Also, the system could be used in conjunction with verifying employment information on deadbeat dads.

Another advantage is that financial institutions will reduce loan losses by incorporating an additional underwriting tool that will provide emphasis on employment stability and will become a predictor of applicant's future ability to pay. Another advantage is that insurance cost will be reduced (for employers) by premium credits available for the employment of applicants with a threshold benchmark weighted score. As an example, XYZ Insurance Company will provide premium credits to workers compensation insurance coverage for all risk that maintain an employment workforce with a weighted score of 500 or greater. This commitment reflects improved applicant hires and less risk for loss. Yet another advantage to the insurance industry as they spread the risk amount insured. More insured contractors will benefit in the future due to decreased insurance cost for participation.

Still yet another advantage is that hospitals and health care organization will be protected by tracking all employees' specialization credentials and recurrent training as well as past performance by prior employment. CPR and other specialized credentials will be updated through association sponsored links, like Red Cross, etc. Also, hospitals that hire agency “pool” nurses for PRN (as needed) shifts will have complete documentation of these health care professionals. Hospitals are at risk due to poor background information on specific nurses that are sent at the last minute to simply cover nurse-patient ratios.

Yet another advantage is that commercial trucking firms will be able to protect themselves from CDL expirations and will have a management tool for all specific credential expirations as well as improved information on new hires, contract drivers and lease operations. The energy sector contains several industry specific training programs for various disciplines and the weighted score will become a source of acknowledgment and verification of completion by data links to these specific industry criteria. Full disclosure instantly will be very important to cyclical industries which have been known to hire large numbers of employees in a short period of time. The weighted score used in this invention will aid these cyclical industries with staffing.

Another advantage is that the system will assist employees to be better employees in order to maintain their score and achieve compensation incentives/promotions for enhanced work performance. Yet another advantage is that the system will assist employers and independent contractors to be better businesses, as they will be subject to full disclosure of performance. An applicant can use the web or call a telephone number with a proper pin identification and obtain information regarding contractors.

A feature of the present invention is that the system allows for a one-stop shop for recordation of employee history. Another feature is good performers can be recognized quickly and rewarded, while poor performers will not. Another feature is that incentive pay will induce employees to achieve better scores. Yet another feature is that it is possible that employees with good weighted scores and marginal credit scores will be rewarded, as their ability to pay will be eased.

Another feature is that operational efficiencies will be experienced for all member companies with the reduction of human resource labor through the incorporation of automation and instantaneous file updating for minute-to-minute accuracy. Yet another feature is that an applicant can use the system as an updated resume. From the base line, all information will be updated instantaneously for real time accuracy. When a request exist for a resume, the applicatnt can reference the system. Once the applicant provides the personal identification code, access will be granted.

Another feature is that employer special achievement awards will be credited for enhancement of weighted scores, likewise, complaints filed against the employer will be harmful. The system seeks to achieve standardization among all industries and consumers will have access to information.

An advantage of the third embodiment, which is the most preferred embodiment of this disclosure, includes protecting consumers from poor performing businesses. Another advantage is that the system has a component that allows for consumer evaluation. Still yet another advantage is that the consumer can participate in the scoring of employers. Another advantage is that the system protects vendors from poor performing relationships and provides for vendor evaluation component. Vendors could use business benchmark scores to maintain status on a vendor list. Yet another advantage is that the most preferred embodiment of this disclosure allows for employee participation in the evaluation of the employer. This participation allows for constructive information on improving workplace environment, conditions, etc. Another advantage is that the system allows means for prospective employees to anaylize the employer by using the rating of existing employees. Still yet another advantage is that the process acknowledges specific industry associations to participate in the evaluation of members through evaluation surveys. Yet another advantage of this most preferred embodiment, the process allows for special accreditation programs to participate in the evaluation process and utilize the specially calculated and weighted score for compliance.

A feature of the third and most preferred embodiment is that parents and guardians will be able to rate/evaluate teachers. Hence, parents will be able to voice opinions on individual teachers. Another feature of the most preferred embodiment is that clients of professionals will be able to voice opinions. The professionals include lawyers, accountants, physicians, etc.

### BRIEF DESCRIPTION OF THE DRAWINGS

FIG. 1 is flow chart schematic depicting a first embodiment of the present novel system.

FIG. 2 is a flow chart schematic depicting a second embodiment of the present novel system.

FIG. 3 is a flow chart diagram depicting input factors for analysis and score weighing according to the present novel system.

FIG. 4 is a data flow chart of the third embodiment, which is the most preferred embodiment, illustrating the generation of an employer score based on multiple surveys.

FIG. 5 is a data flow chart of the third embodiment, which is the most preferred embodiment, illustrating the generation of a professional score based on muliple surveys.

FIG. 6 is a data flow chart of the third embodiment, which is the most preferred embodiment, showing the generation of alert transmissions to selected participants.

### DETAILED DISCUSSION OF THE PREFERRED EMBODIMENTS

The system and method herein disclosed consist of an interactive web-based information resource center for the management of employee/employer credentials as well as prior work history and performance as reported by member resources. The site will assist employers in the management of their most important asset, their employees, as well as provide the public with full disclosure of employer's performance based scoring in order to protect the consumer from fraud and abuse. The created database collects employee credentials and the application of employer performance base scoring. The system may incorporate employee/employer dynamics as well as the management of industry specific requirements such as continuing education requirements, CPR certification for the medical industry, safety training for the energy sector, recurrent training for pilots, etc.

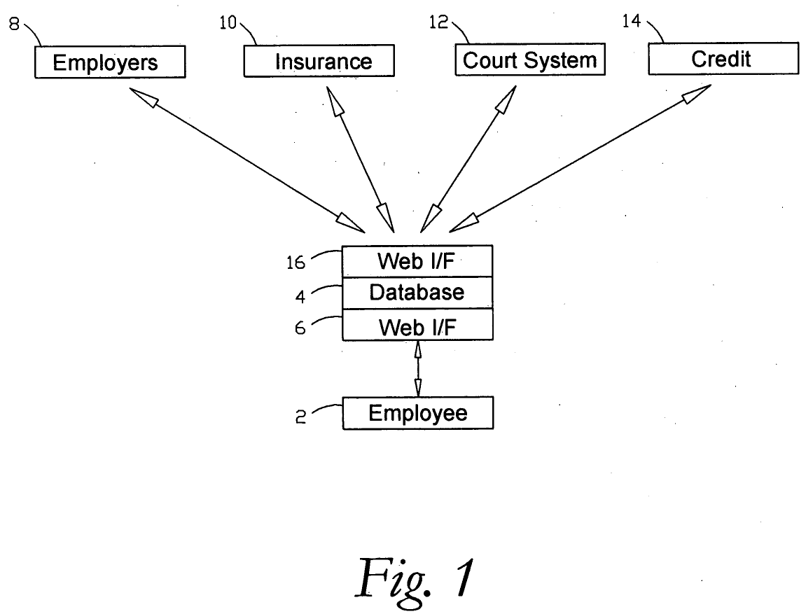

Referring now to FIG. 1, a flow chart schematic depicting a first embodiment of the present novel system will now be described. As shown in FIG. 1, an employee 2 would communicate with the database 4. In the most preferred embodiment, the employee 2 has an employee computer, also referred to as a user processor. The employee computer has means for communication with the Internet and the world wide web.

As per the teachings of the system, the database 4 contains the web interface means 6 so that the employee computer can communicate with the database. The employee computer may communicate (i.e. wireless transmission) data and information, including authorization to obtain data from various third party content custodians, as will be more fully explained later in the disclosure. The employee computer may also authorize payment of any fees required for use of the system.

FIG. 1 also depicts several entities that may provide information to the database 4 about the employee. For instance, employers may provide information to the database. Hence, employers 8 can provide this information to the database. FIG. I also depicts an insurance entity 10 that provides data for the database 4, a court system entity 12 that provides data for the database and a credit entity 14 that provides data for the database. This listing of entities is illustrative. In the most preferred embodiment, the employer entity 8, insurance entity 10, court system 12 and credit entity 14 will communicate with the database 4 via the Internet and world wide web, as shown by the web interface 16, and wherein the web interface 16 is operatively associated with the database 4. In this way, various entities can communicate data about an employee once the employee has submitted the proper authorization.

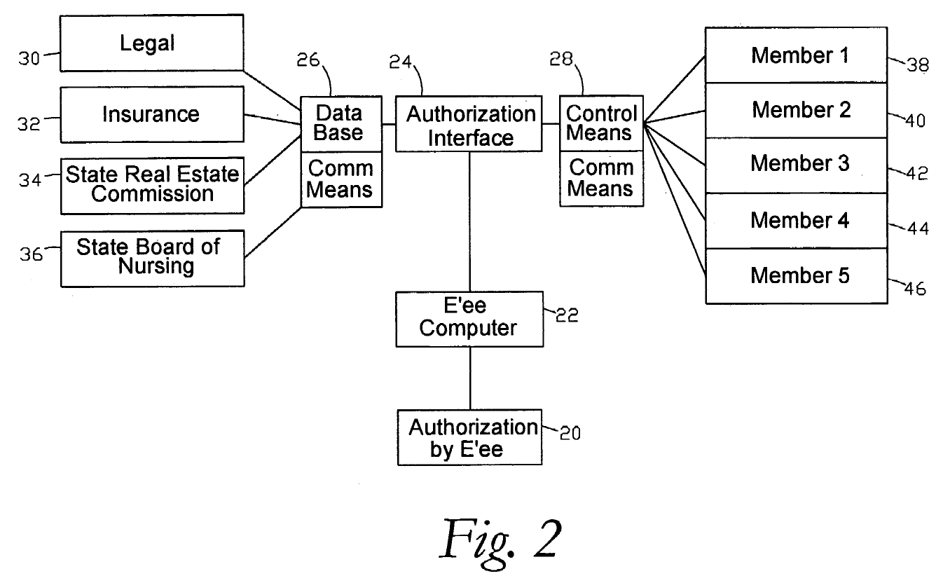

Referring now to FIG. 2, a flow chart schematic depicting a second embodiment of the present novel system will now be described. FIG. 2 is a higher level flow chart from the illustration of FIG. 1. In the embodiment of FIG. 2, an employee gives his authorization 20, and wherein the authorization is sent via the employee computer 22 to authorization interface 24. As depicted, the authorization interface 24 is operatively associated with the database 26 and with the control means 28.

FIG. 2 depicts several entities that will supply data and information to the database 26. More specifically, a legal entity (such as a court system) 30 is shown in communication with the database 26; an insurance entity (such as an insurance company) 32 is shown in communication with the database 26; a state real estate commission 34 is shown in communication with the database 26; and, a state board of nursing 36 is shown in communication with the database 26. The listing of entities is meant to be illustrative. The entities 30, 32, 34, and 36 will communicate with the database 26 via the world wide web in the most preferred embodiment.

Various member entities will be in communication with the database. FIG. 2 depicts five (5) member entities, but this listing is illustrative only. In one preferred embodiment, the member entities will pay a required fee to access the database 26 and any proprietary weighting score accomplished according to the teachings of the present invention. Hence, member entity 38 will communicate with the control means 28, which in turn will communicate with the authorization interface to check on authorization, and if there is authorization, then the member 38 will be allowed access to the data and information sought. FIG. 2 further shows the member 40 in communication with the control means, the member 42 in communication with the control means 28, the member 44 in communication with the control means 28, and the member 46 in communication with the control means 28. Members 40, 42, 44, and 46 receive authorization, information and data as mentioned earlier in the discussion of the member 38.

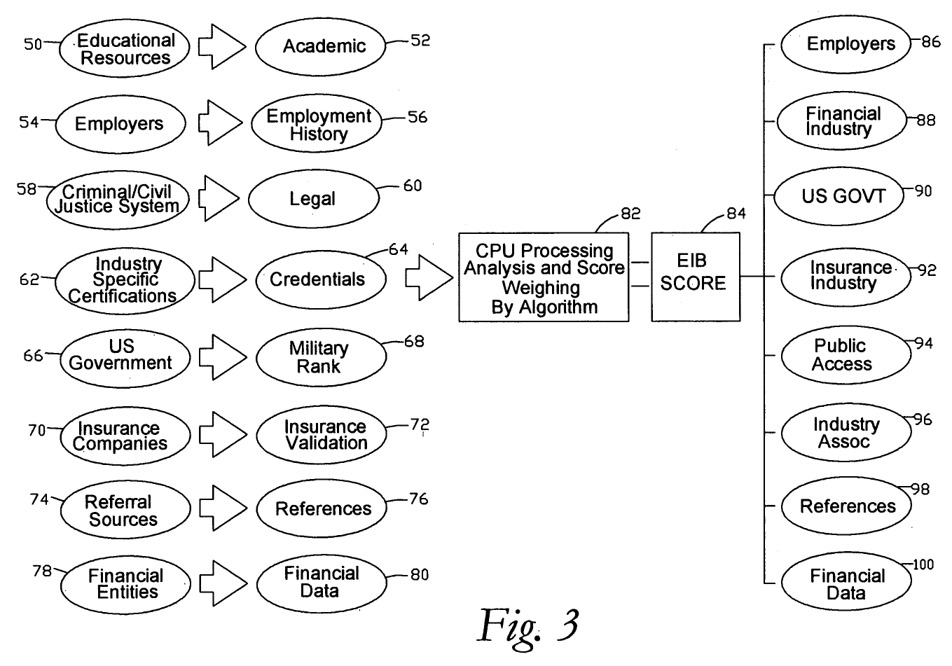

FIG. 3 is a flow chart diagram depicting input factors for analysis and score weighing according to the present novel system. Hence, a source of data can be educational resources 50, wherein academic records 52, such as high school and college transcripts, can be accessed. Another source of information may be from employers 54, wherein employment history 56, such as prior jobs and salary, can be accessed. Criminal/civil justice records can be accessed 58, wherein legal information 60, such as prior convictions, can be accessed. Another source of data is industry specific certification records 62, wherein certification information 64, such as professional licenses, can be accessed. Yet another source of data can be U.S Government information 66, such as military records 68, can be accessed. Information from insurance companies 70 can be gathered, such as insurance premium payment and validation 72. Yet another source of information can be referral sources 74, wherein specific references 76 can be accessed. Still yet another source of information is financial entities 78, and wherein financial data 80 can be accessed.

This information is sent to the central processing unit (CPU) 82 for processing, analysis and score weighting in accordance with the teachings of the present invention. The analysis and score weighing is done by algorithm. A weighted score 84 can then be assigned to that person. It is possible to give a weighted score for a particular factor (i.e. employment history), a group of factors (i.e. academic, military rank, and financial data), or all the factors. The weighted score 84 can then be disseminated to member entities, such as employers 86, a financial entity 88, a government entity 90, an insurance company 92, public access 94, an industry association 96, a specific court 98, or some other entity 100. The listing 86, 88, 90, 92, 94, 96, 98 and 100 is illustrative.

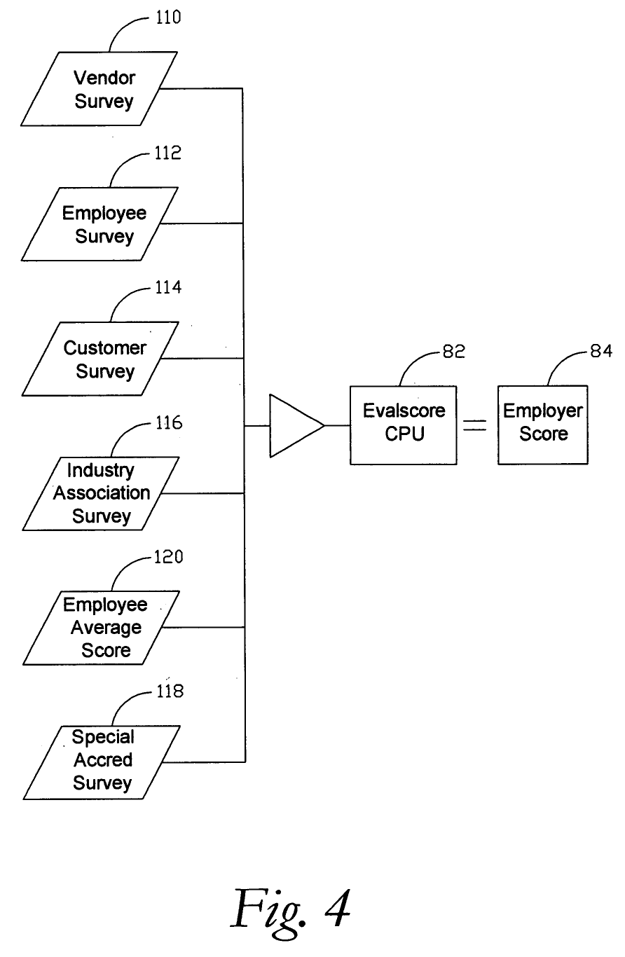

Referring now to FIG. 4, a data flow chart of the third embodiment, which is the most preferred embodiment of this disclosure, illustrating the generation of an employer score based on multiple surveys will now be described. This embodiment allows the employee the ability to participate in the evaluation of the employer. This component will be included in the index criteria along with evaluation by vendors, by customers, by industry associations, and by special accreditation organizations. The evaluation is calculated and weighted via the algorithm for the actual score.

As employers under the weighted score system provide input into the overall scoring on each applicant, this preferred system allows for the employee to anonymously rate the employer, in an employee satisfaction category to be weighted in the overall evaluation. It has been found that corporations utilize proprietary surveys for employees in order to determine the strengths and weaknesses of each division and recommendations for improvement. Employers can use these results to assist in recruiting other competent employees or in advertising to the general public. In the most preferred embodiment, the system can be adapted to include means for parents to evaluate teachers. The process herein disclosed will provide an incentive for teachers to achieve improvement and excellence in the classroom.

FIG. 4 depicts the data that will be entered into the central processor unit 82 that receives and processes the survey data. As noted earlier, like numbers appearing in the various figures refer to like components. More specifically, the survey data includes a vendor survey 110, employee survey 112, customer survey 114, industry association survey 116, special accreditation survey 118. Each survey is a questionnaire designed specifically to ascertain the credentials (i.e. qualifications, skills, competence, etc) of the surveyed party. FIG. 4 also depicts the employee average score 120 that would be an average score of all employees that is utilized in the computation via the algorithm means, and wherein the calculation is carried out within the central processor unit 82. The weighted score 84 can then be assigned to that employer. It should be noted that the entity that responds to the survey is referred to as the respondent; the party that views and participants in the survey results is referred to as the participant; and, the entity being surveyed (i.e. the party being reviewed) is referred to as the surveyed party.

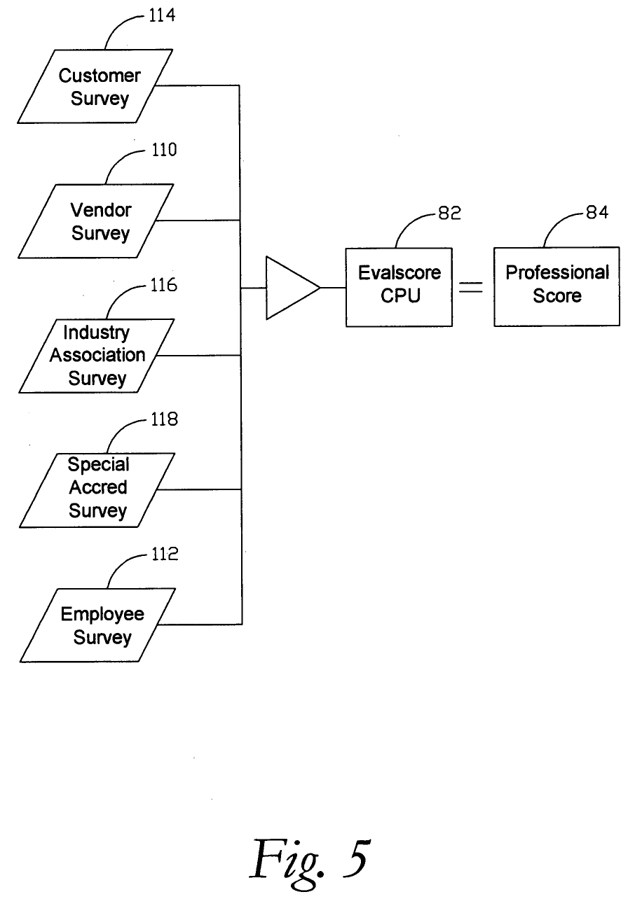

FIG. 5 is a data flow chart of the third and most preferred embodiment of this disclosure illustrating the generation of a professional score based on multiple surveys. Hence, the data being transmitted to the central processing unit 82 includes customer surveys 114, vendor surveys 110, association surveys 116, special accreditation surveys 118 and employee surveys 112. A weighted score 84 is generated via the central processing unit 82 as previously described.

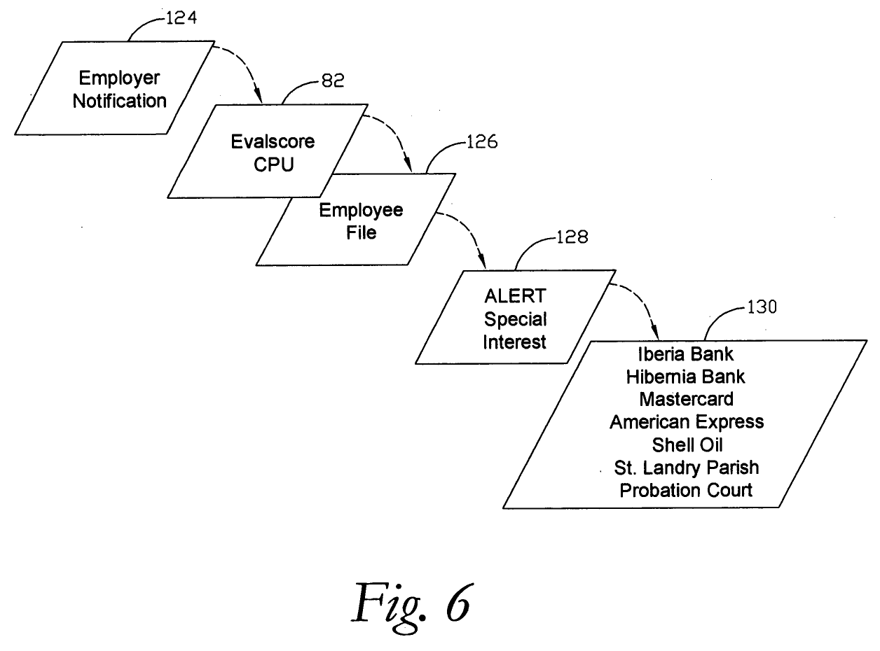

Referring now to FIG. 6, a data flow chart of the third and most preferred embodiment of this disclosure showing the generation of alert transmissions to selected participants will now be described. An alert special interest provision is disclosed to provide instanteous notification of any significant changes to the employer/employee file such as termination, score reduction, etc. The alert function is provided to special interest entities, also referred to as participants, such as insurance companies, licensing boards, banks, credit companies, courts, etc. Special interest entities (participants in this embodiment) will be able to park on an applicant's file for change notification alerts. In the most preferred embodiment, a special interest group with authorization of the applicant may monitor the score and conditions of applicant, and wherein the authorization is granted in part by the payment of an authorization fee.

As illustrated according to the data flow of FIG. 6, and based upon predetermined criteria, once a survey score declines/exceeds a threshold, an employer signal is generated 124, and wherein this signal notification 124 is transmitted to the central processing unit 82. As an example, XYZ Bank makes a loan to applicant based upon his evalscore (Employment Strength/Weakness) and Financial Score based upon existing performance numbers. Bank makes loan at 8% with provisions that applicant meet or exceed his loan based numbers, should applicant's performance cause a decline in the Evalscore, bank could use this opportunity on a variable loan to increase loan rate of interest to reflect the increase risk of applicant. Therefore, at point of sale, applicant would execute authority for bank to “park” on applicant's file as a Special Interest Party (SIP) for alert notification. The bank could use the same model to reduce applicant's rate of interest if score improves. This will give employee the incentive to achieve excellence. Additionally, this could also work with insurance companies for increase/decrease in insurance premiums i.e. risk versus reward.

As seen in FIG. 6, the initiation of the signal notification 124 is downloaded and stored in the employee file 126, and which in turn will generate an alert 128. As per the teachings of this disclosure, the generation of the alert 128 is transmitted to various participants, as seen at 130. The participants will include bank entities, credit entities, court entities, insurance company entities. Please note that this list is illustrative.

As per the teachings of the present invention, lenders with an interest in applicant (i.e. the surveyed party) due to loans, credit cards, etc., will be able to receive instant electronic notification of score changes, job changes, etc. Court systems will be able to monitor defendants (i.e. the surveyed party) for probation violations, child support, garnishments, change of job, change of address. Insurance companies can monitor insured (i.e. the surveyed party) like contractors and if poor performance trends determine the score of the applicant, insurance companies will be able to issue non-renewals and escape risk. General contractors will want to monitor sub-contractors for risk management. If a sub-contractor is receiving consumer complaints that are unresolved, sub-contractor will realize that it is at risk of losing general contractor's relationship. Also, if a surveyed party's performance is poor, insurance programs may be non-renewed resulting in the surrender of the relationship. Insurance companies will be able to provide savings to clients via reduced premiums if the party being reviewed (i.e. the party who is being ranked via the survey) maintains an acceptable weighted score. Additionally, licensing boards could participate in the instant notification of weighted scores when, for instance, an entity under license review by the licensing board falls below a predetermined threshold score. Hence, the license board could chose to non-new, or provisionally accept based in part on the weighted scores. Further, company vendors could participate in the special interest party program for instant notification of potential problems with business relationships.

As an example, an insurance company will require a benchmark weighted score for pricing (risk versus reward), and wherein the insurance company will activate the alert function on a surveyed weighted party file as a special interest party. Therefore, the insurance company will be notified by poor customer evaluations, poor credit history, and the insurance company may choose to non-renew coverages before unnecessary losses occur, therefore saving the insurance company unnecessary claims expense. Hence, instant notification provides warnings to participants that changes are occurring and action may be needed to protect themselves from loss. The system herein disclosed protects banks and credit companies from financial losses. The system also protects insurance companies from unnecessary claim expense by the non-renewal of poor performing companies. The system protects vendors from declining relationships and protects courts from unnecessary investigative expense in processing garnishments due to the instant notification of employment termination and/or reemployment. Additionally, the system protects general contractors by poor performing sub contractors. The system also protects licensing boards from the renewals of poor performing licensees.

Although the present invention has been described with reference to preferred embodiments, workers skilled in the art will recognize that changes can be made in form and detail without departing from the spirit and scope of the invention, as well as any appropriate equivalents thereof

I claim:

1. An interactive employment credential system comprising:
a database comprising survey information of a surveyed party;
authorization means for authorizing access to said database;
control means, operatively associated with said database, for presenting the survey information in a first format;
a survey party processor operatively associated with said control means, and wherein said survey party processor is capable of transmitting authorization to view said survey information;
an alert means for generating an alert when the survey information changes based on predetermined criteria;
a transmitting means for transmitting the alert to participants in the system.

2. The system of claim 1 further comprising:
a participant processor in communication with said authorization means, and wherein said participant processor is capable of requesting authorization to download said survey information for the participant.

3. The system of claim 2 wherein said control means comprises means for requiring that said participant processor request includes payment of a user request fee.

4. The system of claim 3 wherein said control means includes means for requiring that said surveyed party's processor authorization includes payment of a participant's request fee.

5. The system of claim 4 said first format of said survey information includes a weighted score based on predetermined factors and calculated using a system.

6. The system of claim 5 wherein said survey information consisting of health information, education information, criminal information, professional certification information.

7. A method of providing survey information of a surveyed party comprising:
storing said survey information on a database;
transmitting authorization to view said information via a surveyed party processor operatively associated with a control means;
authenticating and authorizing third parties access to said database;
presenting said survey information in a first format via said control means, and wherein said control means is operatively associated with said database.

8. The method of claim 7 further comprising:
communicating a participant processor with said control means;
requesting authorization to download said survey information with said participant processor.

9. The method of claim 8 wherein said the step of requesting authorization to download said survey information includes:
paying a request fee by said participant in order to view said survey information.

10. The method of claim 9 wherein said step of transmitting authorization to make available survey information via said surveyed party's processor includes:
paying a user fee by said surveyed party in order to post the surveyed party's information to the database.

11. The method of claim 10 said step of presenting said survey information in a first format includes utilizing an algorithm to calculate a weighted score of said survey information.

12. The method of claim 10 wherein said survey information is selected from the group consisting of a financial score, an academic score, an employment score, a character score, a medical score, a professional credential score, a reference score, a military score, a legal score or an insurance score.

13. The method of claim 8 further comprising:
transmitting an alert based on a predetermined criteria selected from said survey information.

14. The method of claim 13 wherein said participant is selected from the group of bankers, insurance companies, lenders, employers, and court systems.
